(19) United States
(12) Patent Application Publication
(10) Pub. No.: US 2009/0098889 A1
(43) Pub. Date: Apr. 16, 2009

(54) Wireless device location alerts on battery notification events

(76) Inventors: Bob Barcklay, Berkeley, CA (US); Ritesh Bansal, Fremont, CA (US); Kevin Tsurutome, San Francisco, CA (US)

Correspondence Address: MANELLI DENISON & SELTER PLLC, 7th Floor, 2000 M Street , N.W.,, Washington, DC, 20036-3307, US

(21) Appl. No.: 12/232,045

(22) Filed: Sep. 10, 2008

Related U.S. Application Data
(60) Provisional application No. 60/960,018, filed on Sep. 11, 2007.

(51) Int. Cl. H04W 64/00

(52) U.S. Cl. 455/456.6

(57) ABSTRACT

As part of a handset finder service, a customer will download and install a small application, e.g., handset finder application, onto their wireless device. The first time this handset finder application runs, it registers to receive battery notification events from the device (or if not available, another type of wake-up event, like a timer or SMS wake-up). These events wake-up the application, which will determine whether a “low power” threshold has been reached. When this occurs, the application initiates a location query. The application will submit a determined location to a handset finder server.

The present application claims priority from U.S. Provisional Application 60/960,018, entitled “GENERATING DEVICE LOCATION ALERTS IN BATTERY NOTIFICATION EVENTS” to Barcklay et al., filed Sep. 11, 2007, the entirety of which is expressly incorporated herein by reference.

### BACKGROUND OF THE INVENTION

1. Field of the Invention

This invention relates generally to location based wireless services, and more specifically, to location enabled applications for wireless mobile devices.

2. Background of Related Art

Wireless devices, such as cellular telephones, personal data assistants, laptop computers, etc., have become commonplace within our modern society. Their battery power creates autonomy. However, autonomy creates opportunity for those devices to be lost or stolen.

Services exist to allow recovery of a lost or stolen wireless device. A handset finder service allows cell phone customers to locate their wireless device when it is lost or stolen. This service relies on a network initiated location request that queries the device for its current location.

The handset finder service requires that the wireless device be turned on to operate properly. If the wireless device is not turned on, it is not able to respond to the network location request. Since a lost or stolen wireless device is likely to be on and using its battery power when initially lost, the handset finder application must locate the lost wireless device before its battery power is exhausted. However, if the handset finder service is not activated prior to battery power being exhausted, the opportunity to locate the lost wireless device has passed.

There is a need for a system and method that can determine a wireless device's current location before battery power is exhausted.

### SUMMARY OF THE INVENTION

In accordance with the principles of the invention, location information is provided for a wireless device by determining when a battery level is below a predetermined threshold. A current location is determined for the wireless device when the battery level is determined to be below the predetermined threshold, and then the current location is transmitted.

In accordance with the principles of the invention, a system for providing location information comprises a wireless device to determine if a battery level is below a predetermined threshold. A location determiner determines a current location for the wireless device when the battery level is determined to be below the predetermined threshold, and a transmitter transmits the current location.

### BRIEF DESCRIPTION OF THE DRAWINGS

Features and advantages of the present invention will become apparent to those skilled in the art from the following description with reference to the drawings, in which:

FIG. 1 shows a system for transmitting a request for and receiving a handset finder application, in accordance with the principles of the present invention.

FIG. 2 shows a wireless device itself including a handset finder application, in accordance with the principles of the present invention.

FIG. 3 shows an exemplary method of obtaining a location of a lost handset, in accordance with the principles of the present invention.

FIG. 4 shows an exemplary method of activating and executing a handset finder application, in accordance with the principles of the present invention.

FIG. 5 shows an exemplary method of executing a timer execution event, in accordance with the principles of the present invention.

### DETAILED DESCRIPTION OF ILLUSTRATIVE EMBODIMENTS

A handset finder service is provided In accordance with the principles of the present invention. A customer downloads and installs handset finder application onto their wireless device. Such a small application is preferably downloaded and installed on any battery powered suitable type wireless device, e.g., cellular telephone, personal data assistant, laptop computer, etc.

The first time this handset finder application runs, it preferably registers to receive battery notification events from the wireless device. These events wake-up the handset finder application, which determines whether a “low power” threshold has been reached. When this occurs, the handset finder application initiates a location query. The handset finder application will submit a determined location to a handset finder server.

The handset finder server preferably distributes the determined location to any entity with the proper authority to receive location information associated with the relevant wireless device. For example, the handset finder server can disseminate the determined location to an owner of the wireless device, the police, a cellular service provider, pre-designated authorized persons, etc.

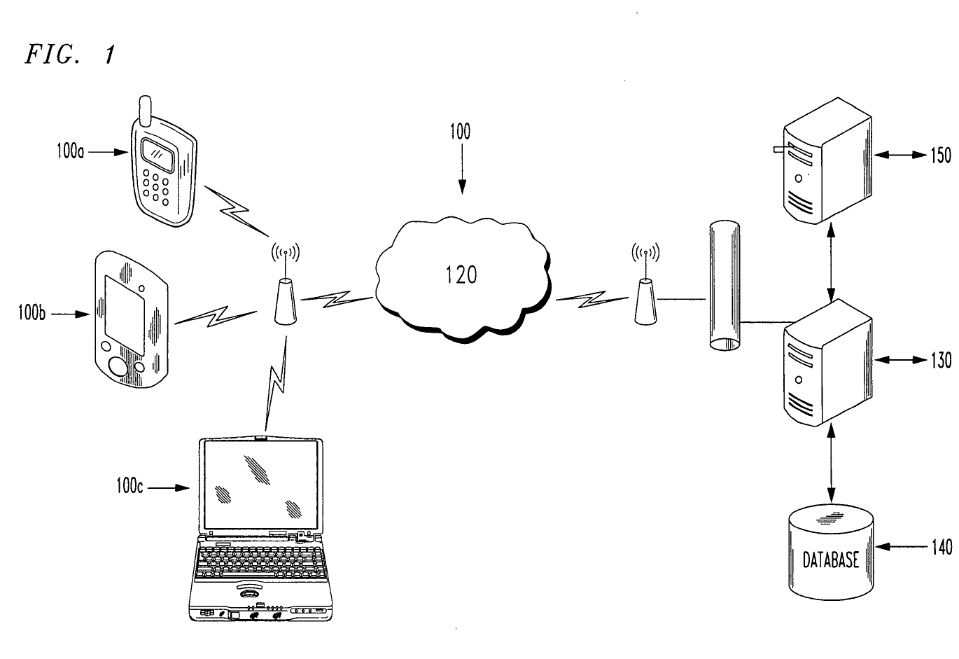

FIG. 1 shows a system for transmitting a finder request for a handset and receiving handset finder information, in accordance with the principles of the present invention.

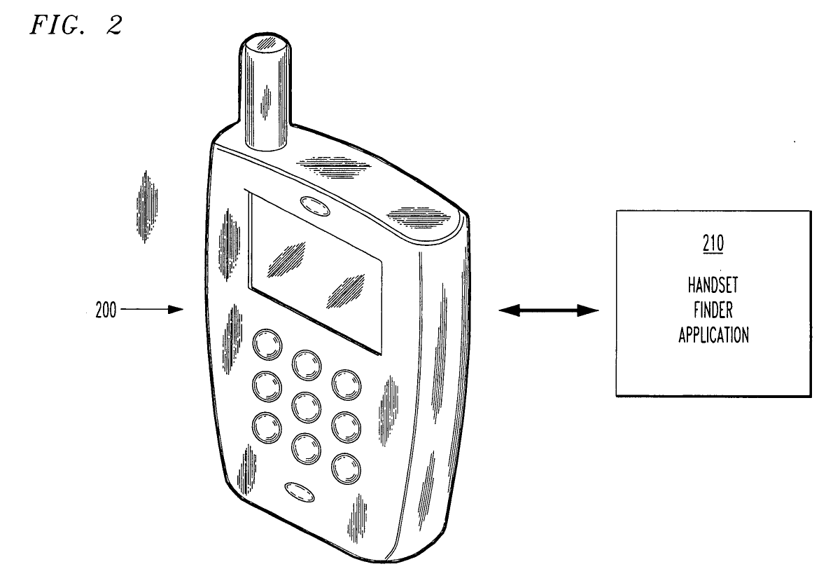

In particular, as shown in FIG. 1, a system 100 for transmitting a finder request for a handset includes a handset finder application 210 (shown in more detail in FIG. 2). The system used to locate a lost handset include, e.g., a handset finder application 210 located, e.g., in various wireless devices 100a, 100b, and 100c, a wireless network 120, a handset finder server 130, a handset finder application database 140, and a location server 150.

Instead of using a handset finder service that relies on a network initiated location request to determine a current location of any wireless device, wireless devices 100a, 100b or 100c, themselves, in accordance with the principles of the present invention, include a handset finder application 210. In operation, the handset finder application 210 allows the wireless device itself to monitor if a battery level that falls below a “low battery” threshold. At that time, current location information for a relevant wireless device 100a, 100b or 100c is determined. The current location information may be determined locally, if the relevant wireless device 100a, 100b or 100c is able to make such a determination, or from a suitable location server 150.

In instances where a local determination of current location information cannot be made locally at any of wireless devices 100a, 100b, and 100c for whatever reason, a location server 150 can act as a backup source of current location information for a given wireless device.

The “low battery” threshold level can be pre-programmed into the handset finder application 210. Alternately, the “low battery” threshold level can be set by a user of the wireless device 100a, 100b or 100c. An option can be provided in a wireless devices configuration option menu to give a user the option to set the “low battery” threshold. If a user allows their wireless device 100a, 100b, or 100c to routinely drain down to an extremely low state before charging, which could frequently trigger the handset finder application 210, the user can lower the threshold to reduce the number of times the handset finder application 210 is activated.

The wireless network 120 allows the various wireless devices 100a, 100b and 100c to communicate with the handset finder server 130 (shown in FIG. 1). Any suitable wireless network can be employed that allows data communications for transmitting a request for a handset finder application 210 and receiving a handset finder application 210, and communicating location information between the various wireless devices 100a, 100b, and 100c and the handset finder server 130.

The handset finder server 130 receives finder requests for a handset from an appropriate requesting element of a wireless network 120. In response, a database query is formulated by the handset finder server 130 from parameters associated with the received finder request for a handset. Such parameters can include a current operating system, a hardware description for the wireless device, an indication if the device has location capabilities, etc. The database query is submitted by the handset finder server 130 to the handset finder application database 140 to search the contents of the handset finder application database 140 for entries that match the received parameters.

The handset finder server 130 can distribute the current location for a relevant wireless devices 100a, 100b or 100c to any entity with the proper authority to receive location information associated with the relevant wireless device 100a, 100b or 100c. For example, the handset finder server 130 can disseminate determined location information to an owner of the wireless device 100a, 100b or 100c, the police, a cellular service provider, pre-designated authorized persons, medical personnel, etc.

The handset finder application database 140 can be managed by any number of database programs, such as, Some Oracle, Sybase, mySQL, Lotus Approach, Microsoft Access, Filemaker, etc. Any database program that allows for the retrieval of location configuration data from parameters can be used with the invention, such as a carrier network identification and at least one application identification.

The handset finder server 130 and handset finder application database 140 are described herein for simplicity as being separate components. However, the handset finder application database 140 can exist within the handset finder server 130. In such an instance, the description above of the handset finder server 130 submitting a database query to the location configuration database 140 may remain the same.

In the event that any of the wireless devices 100a, 100b or 100c do not contain location determination components, e.g., GPS circuitry, the location server 150 can be employed by the handset finder server 130 to determine a current location for any of the wireless devices 100a, 100b, and 100c. Once triggered by any of the wireless devices 100a, 100b, and 100c upon a “low battery” threshold condition, the handset finder server 130 can transmit a finder request for a current location of a particular wireless device(s) 100a, 100b or 100c to the location server 150. In response, the handset finder server 130 receives a current location from the location server 150 for the particular wireless device 100a, 100b or 100c.

In instances where any of the wireless devices 100a, 100b, and 100c cannot determine their current location locally, such as when they cannot obtain a satellite fix to necessary GPS satellites, the location server 150 can perform a backup function to the otherwise usual location capability built into the wireless devices 100a, 100b, and 100c. In such an instance, a relevant wireless device 100a, 100b or 100c would send a notification of a “low battery” threshold condition to the handset finder server 130 together with an indication that a local location determination could not be performed. The handset finder server 130 then transmits a finder request for a current location of a particular wireless device 100a, 100b or 100c to the location server 150. In response, the handset finder server 130 receives a current location from the location server 150 for a particular wireless device 100a, 100b or 100c.

FIG. 2 shows a wireless device itself including a handset finder application, in accordance with the principles of the present invention.

In particular, as shown in FIG. 2, a wireless device 200 includes a handset finder application 210. Within the wireless device 200, the memory storage area 205 stores the handset finder application 210. The handset finder application 210 can include various modules for performing the various functions disclosed herein. For instance, the exemplary handset finder application 210 includes a battery level detector module 220, an optional location information detection module 230, and a notice transmitter module 240.

The memory storage area 205 can be any suitable computer memory, e.g., short term RAM type memory, and/or long term TOM type memory. For example, the memory storage area 210 can be a random access memory (RAM), a read-only memory (ROM), a hard drive, a solid state drive, a detachable memory card, etc. An operating system, processing unit, etc. operating on the wireless device 200 preferably executes the handset finder application 210 from the memory storage area 205.

In the disclosed embodiment, battery level is monitored, either continuously, periodically, or sporadically. While continuous monitoring of battery level is possible and within the principles of the present invention, it is not feasible on most devices to have an application continuously running and checking the battery level because it would consume too much power.

If the relevant wireless device does not support battery wake up events, the handset finder application 210 preferably attempts to register timer wake-up events. Failing that, the handset finder application 210 may register to receive short messaging system (SMS) wake up messages with the handset finder server 130 (FIG. 1).

Upon detection of a “low battery” threshold, the handset finder application 210 optionally activates the location information detection module 230. At that time, the location information detection module 230 determines current location information for a particular wireless devices 100a, 100b, and 100c to be found. In the event that the particular wireless device(s) 100a, 100b, and 100c lacks an ability to detect its current location itself or is unable to determine current location information for whatever reason, the handset finder server 130 can alternately obtain current location information from the location server 150.

The notice transmitter module 240 formulates a notice data packet 250 that includes a notice that the particular wireless device(s) 100a, 100b or 100c has reached a “low battery” threshold. If the particular wireless device 100a, 100b or 100c is able to detect current location information itself, a notice data packet 250 may further include current location information for the particular wireless device 100a, 100b or 100c. The notice transmitter module 240 activates transmission circuitry associated with the particular wireless device 100a, 100b or 100c to transmit the notice data packet 250 to the handset finder server 130.

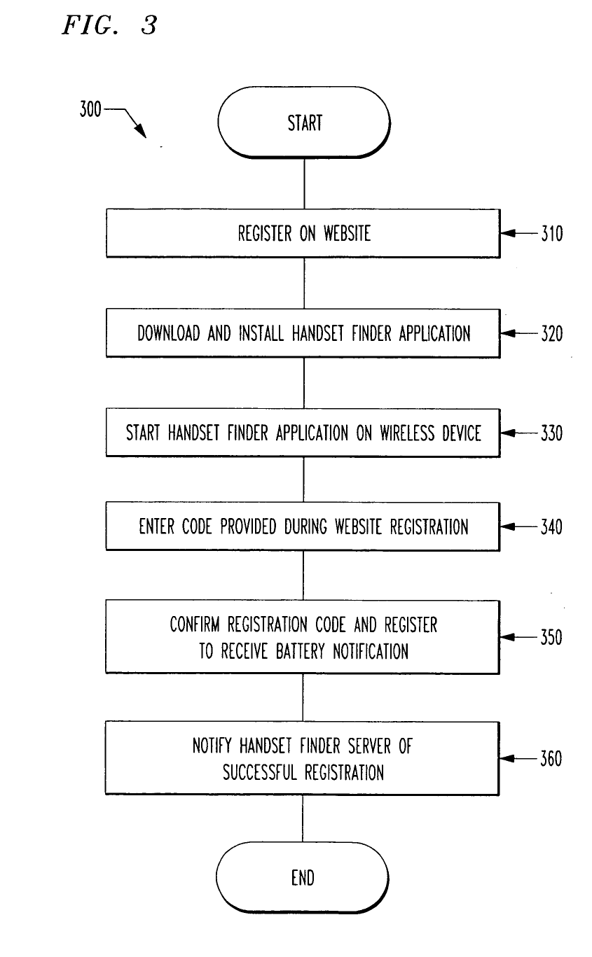

FIG. 3 shows an exemplary method of obtaining a location of a lost handset, in accordance with the principles of the present invention.

In particular, a method 300 of obtaining a location of a lost handset (as implemented in an appropriate handset finder application 210) begins with step 310, of FIG. 3, in which a user from at any wireless devices 100a, 100b, and 100c registers with an appropriate website. The exemplary website provides a portal from which a user can initiate a finder request for a lost handset, download a location of a lost handset, and receive notice that the handset finder application's 210 registration was successful. Registration preferably requires a username and password that is associated with a particular user. Upon proper registration, a user may be provided with a registration code that will be used during activation and/or installation of the handset finder application 210.

In step 320, upon a user entering in their proper username and password in step 310, a handset finder application 210 is retrieved by handset finder server 130 from handset finder application database 140, as discussed above. The handset finder application 210 is downloaded to any of wireless devices 100a, 100b, and 100c that initiated a request for a handset finder application 210.

In step 330, the handset finder application 210 that was downloaded in step 320 is executed by the relevant wireless device 100a, 100b or 100c that downloaded the handset finder application 210.

In step 340, a user of the relevant wireless devices 100a, 100b or 100c that downloaded the handset finder application in step 320 is prompted to enter the registration code provided during the website registration process in step 310.

In step 350, the registration code entered in step 340 is compared to the registration code given to the user in step 310. Upon confirmation that the entered registration code matched the registration code provided to the user in step 310, the downloaded handset finder application 210 will register to receive notification when a battery status or level has changed. This event/notification framework is currently available on BREW3.1 devices. The “low battery” condition described herein effectively wakes up the handset finder application 210, allowing it to take action based on the event information. If this event is not supported by the particular wireless device, a timer event or server initiated SMS wake-up can be registered.

In step 360, the handset finder application 210 from a relevant wireless device 100a, 100b or 100c preferably notifies the handset finder server 130 that it has successfully registered for battery notification events.

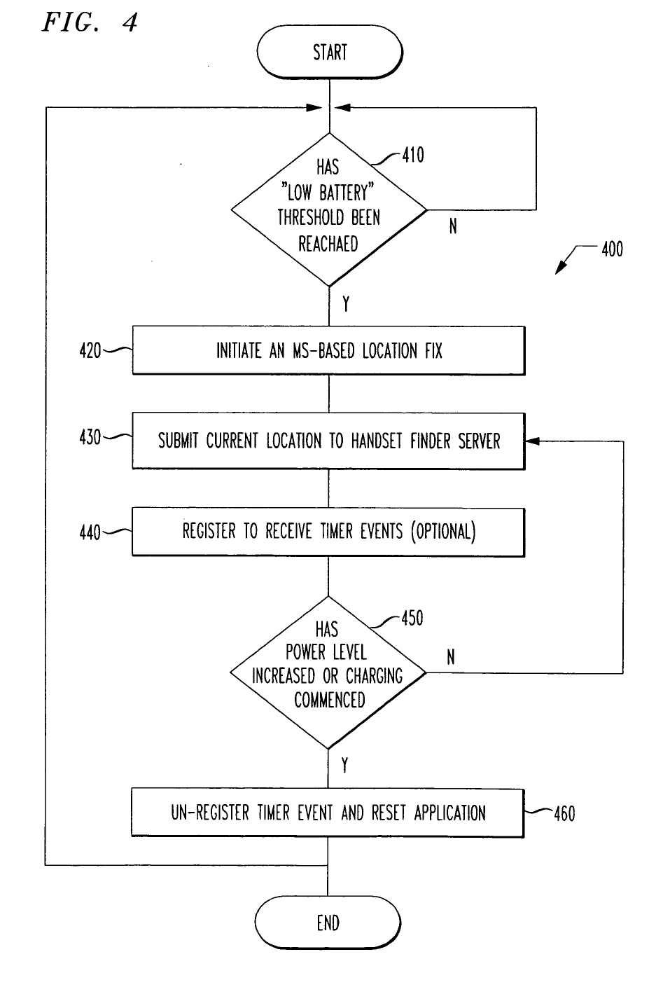

FIG. 4 shows an exemplary method of activating and executing a handset finder application, in accordance with the principles of the present invention. Each registered battery event will wake up the handset finder client application.

In particular, a method 400 of activating and executing a handset finder application 210 begins with step 410, of FIG. 4. The handset finder application 210 is activated by some event, for example a low battery event, a timer wake-up, or an SMS wake-up. A decision is made if a “low battery” threshold has been reached. If a “low battery” threshold has not been reached, the handset finder application 210 shuts down or otherwise goes inactive until the next wake-up or monitoring event. If the “low battery” threshold has been reached or exceeded, step 410 proceeds to step 420.

In step 420, if a relevant wireless device 100a, 100b or 100c contains the necessary hardware to perform a local location determination, a mobile station-based (MS-BASED) location fix is initiated to determine a current location for the particular wireless device 100a, 100b or 100c.

In step 430, the current location information from step 420 determined by any of the wireless devices 100a, 100b, and 100c is transmitted over the wireless network 120 to the handset finder server 130.

In step 440, in the exemplary embodiment, a user can optionally register to receive timer events at an interval configured by the user during the registration process. If the user has so configured their wireless device, this optional event registration ensures that the particular wireless device 100a, 100b or 100c will continue to send out its current location information until it runs out of power.

Repeated notification of a particular wireless device's 100a, 100b or 100c current location is particularly useful for wireless devices that are in transit. Preferably the user profile includes regular and low power settings so that the registered events and frequency may be adjusted accordingly.

In step 450, a decision is made if a power level for any of the wireless devices 100a, 100b, and 100c executing a handset finder application 210 increases, or if a battery charge condition is activated. If the conditions are not met in step 450, the process proceeds to step 430. If any of the conditions are met in step 450, then the process proceeds instead to step 460.

In step 460, the event timer registered in step 440 is un-registered (or otherwise de-activated) and the state of the handset finder application 210 is reset. The process of activating and executing a handset finder application 210 then proceeds to step 410 to monitor if a “low battery” threshold condition has again occurred.

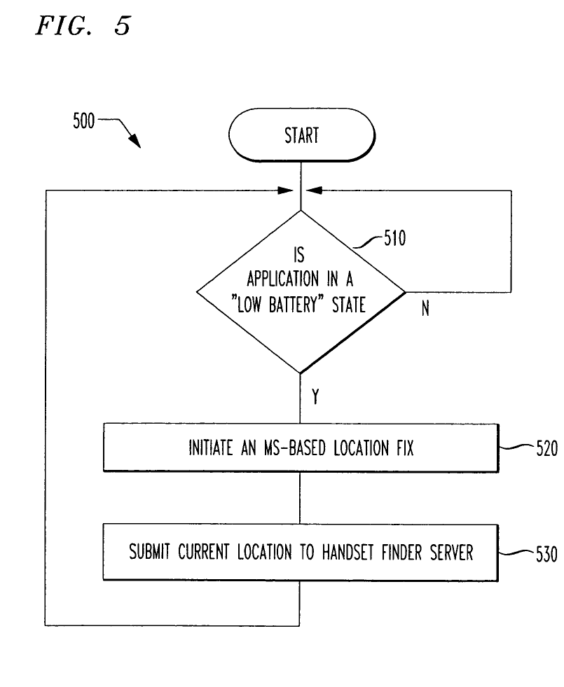

FIG. 5 shows an exemplary method of executing a timer execution event, in accordance with the principles of the present invention.

In particular, a method 500 of executing a timer execution event begins with step 510, of FIG. 5. A decision is made if a handset finder application 210 has detected a “low battery” state in step 510. If the handset finder application 210 has detected a “low battery” state, the process proceeds to step 520. On the other hand, if the handset finder application 210 has not detected a “low battery” state, then the process repeats in a continuous loop to continually monitor for a “low battery” state.

In step 520, an MS-BASED location fix is initiated from a particular wireless device 100a, 100b or 100c.

In step 530, the current location information as determined from the MS-BASED location fix from step 520 is submitted to the handset finder server 130. The process of executing a timer execution event proceeds to step 510 to monitor if a particular handset is still in a “low battery” state.

The present invention described herein has particular applicability to developers of location enabled wireless applications.

While the embodiments disclosed herein are for wireless devices that do not have a handset finder application already installed, the principles disclosed herein apply equally to installation and/or activation of a handset finder application prior to a customer receiving their wireless device. In such an event, the determination of a current location of a wireless device upon occurrence of a monitored “low battery” condition, timer expiration, or other event would remain the same.

While the invention has been described with reference to the exemplary embodiments thereof, those skilled in the art will be able to make various modifications to the described embodiments of the invention without departing from the true spirit and scope of the invention.

What is claimed is:

1. A method of providing location information for a wireless device, comprising:
determining a battery level is below a predetermined threshold;
determining a current location for said wireless device upon said battery level being determined to be below said predetermined threshold; and
transmitting said current location.

2. The method of providing location information for a wireless device according to claim 1, wherein:
said wireless device is a cordless telephone.

3. The method of providing location information for a wireless device according to claim 1, wherein:
said transmitting transmits said current location over a cellular wireless network.

4. The method of providing location information for a wireless device according to claim 1, further comprising:
initiating a mobile station-based (MS-BASED) location fix.

5. The method of providing location information for a wireless device according to claim 1, wherein:
said transmitting said current location transmits to a handset finder server.

6. The method of providing location information for a wireless device according to claim 1, further comprising:
downloading a handset finder application to said wireless device.

7. Apparatus for providing location information for a wireless device, comprising:
means for determining a battery level is below a predetermined threshold;
means for determining a current location for said wireless device upon said battery level being determined to be below said predetermined threshold; and
means for transmitting said current location.

8. The apparatus for providing location information for a wireless device according to claim 7, wherein:
said wireless device is a cordless telephone.

9. The apparatus for providing location information for a wireless device according to claim 7, wherein:
said transmitting transmits said current location over a cellular wireless network.

10. The apparatus for providing location information for a wireless device according to claim 7, further comprising:
means for initiating a mobile station-based (MS-BASED) location fix.

11. The apparatus for providing location information for a wireless device according to claim 7, wherein:
said means for transmitting said current location transmits to a handset finder server.

12. The apparatus for providing location information for a wireless device according to claim 7, further comprising:
means for installing a handset finder application on said wireless device.

13. The apparatus for providing location information for a wireless device according to claim 7, further comprising:
means for downloading a handset finder application to said wireless device.

14. A system for providing location information, comprising:
a wireless device to determine if a battery level is below a predetermined threshold;
a location determiner to determine a current location for said wireless device upon said battery level being determined to be below said predetermined threshold; and
a transmitter to transmit said current location.

15. The system for providing location information according to claim 14, wherein:
said wireless device is a cordless telephone.

16. The system for providing location information according to claim 14, wherein:
said transmitter is a cellular transmitter.

17. The system for providing location information according to claim 14, further comprising:
an initiator to initiate a mobile station-based (MS-BASED) location fix.

18. The system for providing location information according to claim 14, wherein:
said transmitter transmits said current location to a handset finder server.

19. The system for providing location information according to claim 14, further comprising:
an installer to install a handset finder application on said wireless device.

20. The system for providing location information according to claim 14, further comprising:
a downloader to download a handset finder application to said wireless device.
